(19) United States
(12) Patent Application Publication
(10) Pub. No.: US 2026/0027765 A1
(43) Pub. Date: Jan. 29, 2026

(54) FORMING APPARATUS AND METHOD

(71) Applicant: Stirling Moulded Composites Limited, Burnley (GB)

(72) Inventor: David Taylor, Burnley (GB)

(73) Assignee: Stirling Moulded Composites Limited, Burnley (GB)

(21) Appl. No.: 19/341,674

(22) Filed: Sep. 26, 2025

Related U.S. Application Data
(63) Continuation of application No. PCT/EP2024/058395, filed on Mar. 27, 2024.

(30) Foreign Application Priority Data
Mar. 29, 2023 (GB) 2304576.8

(51) Int. Cl. B29C 51/08; B29C 51/20; B29C 51/26; B29L 31/00; B29L 31/48

(52) U.S. Cl. CPC B29C 51/082; B29C 51/20; B29C 51/265; B29L 2031/4821; B29L 2031/768

(57) ABSTRACT

There is disclosed a method of manufacturing an article, the method comprising the steps of: providing a material; heating the material; restricting an edge or region of the material within a frame element; moving a mould towards the frame or vice versa such that the material is in contact with the mould.

### CROSS REFERENCE TO RELATED APPLICATIONS

This application is a continuation of International Application PCT/EP2024/058395 filed Mar. 27, 2024, which claims the benefit under 35 USC § 119 of United Kingdom Application 2304576.8 filed Mar. 29, 2023, the entire contents of all of which are incorporated herein by reference.

### FIELD OF THE DISCLOSURE

The present invention is in the field of forming moulded shapes from material. In particular, the invention relates to thermoforming using frame elements. In even more particular, the invention relates to forming shapes from a block of material that comprises a plurality of hollow parallel conjoined tubes, or other material with a honeycomb like structure. These formed articles may be used in safety apparatus, such as personal protective equipment, for example cycling helmets and the like.

### BACKGROUND OF DISCLOSURE

There is a need for elements and articles to be formed from materials into a variety of shapes. In particular there is a need to form protective elements for use in helmets, and other protective clothing/equipment to be formed.

It has previously been found that material such as that made from parallel conjoined tubes is well suited to absorbing impacts—as the tubes take a great deal of energy to be compacted, therefore absorbing this impact. This material is therefore well suited to being formed into the shape of protective elements. For example into elements to be fitted into helmets for use in cycling, skiing, snowboarding or the like. These elements may comprise portions to be fitted into the helmet, or an entire undershell sitting as a layer of the helmet structure.

There are very few methods at resent for forming such materials into specific shapes, and each one has significant drawbacks. Patent number EP3900914B1 explains a method of using a membrane and a three-dimensional former/mould to shape a thermoplastic honeycombed sheet material into three dimensional shapes.

The use of a membrane as a means of applying a tension force across the surface of a preheated honeycombed material to shape the material into a three-dimensional form is however problematic.

Stretchable membrane materials, although resilient, tend to lose part of their resilience over time, especially when the membrane is heated and is repeatedly stretched and allowed to relax during manufacturing process cycles.

To achieve formed moulded parts with consistent shape and dimensions the membrane must always apply a consistent tension across the surface of the honeycombed material being shaped. A membrane which has lost some of its elasticity or resilience will apply a weaker tension across the honeycombed material which will result with a moulding with a more relaxed surface formed.

Another disadvantage of using a membrane to apply a tension force across the surface of a preheated honeycombed material to shape it into a three-dimensional shape is that the force generated between the three dimensional former and the membrane is not even across the surface of the honeycombed material. This is the case even if the membrane is not deformed in any way.

The membrane method produces a radial pressure/tension effect across the surface of the honeycombed material with a higher pressure concentrated in the centre of the membrane—radiating outwards to the outer edges of the membrane where the force and pressure/tension are weaker.

In some cases the forces at the edge of the membrane are so weak that little or no pressure/tension is applied via the membrane to the edge region of the material.

The result is a partially formed piece of material which does not have the desired three-dimensional shape around the edges. Instead, the edges of the honeycombed material flair out in an undesirable manner. This means that articles manufactured in this way are less suitable for protective equipment.

The invention below aims to solve these and other associated problems by providing a new alternative method for the shaping of materials.

### STATEMENTS OF INVENTION

Aspects of the invention are set out in the independent claims. Optional features are set out in the dependent claims.

In accordance with a first aspect there is provided a method of manufacturing an article, the method comprising the steps of: providing a material; heating the material; restricting an edge or region of the material within a frame element; moving a mould towards the frame or vice versa such that the material is in contact with the mould. This may be highly advantageous because this provides an even force around the edge of the material—and it is the edge that requires the majority of force for shaping. Much less force is applied to the centre of the material by the frame (the mould of course applies some force to this portion of the material). This is therefore purposefully not an even distribution of force applied by the frame element, and this allows the shaping of helmet elements and the like. This creates stronger articles for protective equipment, and allows the eventual shape to be closer to the intended shape/configuration.

Optionally, heating the material comprises blowing heated air through the material. This may heat the material, and advantageously may heat one side more than the other. As the inside of the eventual formed shape bends by a greater amount this non-homogenous heating is also advantageous.

Optionally, further comprising shaping the material through the contact with the mould.

Optionally, wherein the edge or region is either: the edge of the portion of the material that is being shaped by the mould, or the side wall of the material. The first of these options may allow for large elements, such as hemispheres for use as an entire layer of a helmet structure, to be formed. The second of these methods may allow for segments to be inserted into a helmet to be formed, whilst minimising the quantity of wasted material from the manufacture process.

Optionally, the frame element is a substantially rigid element. This may allow the force to be transmitted to the edge portion of the material and for this to effectively shape the material as desired.

Optionally, the frame element contains a cut-out. This may allow the material to be pushed therethrough to aid with shaping.

Optionally, this is located in the centre of the frame element. This may allow for an entire perimeter of the cut-out to contact the edge of the material.

Optionally, the shape of the cut-out corresponds to the cross-sectional shape of the mould. This may (with any pre-cutting if required) allow the desired shape of the eventual article to be readily and simply made.

Optionally, the frame element extends down by between 5 mm-20 mm, and preferably 6 mm-12 mm. This extension down (i.e. perpendicular to the plan in which the cut-out is in) may provide additional tension to the material as it is pushed through the cut-out. This may stop the deformation of the cross sectional shape of any of the conjoined parallel tubes. These measurements have been found to minimise these deformation patterns. Optionally, the extension down is positioned at a midway point in the longitudinal direction of the cut-out of the frame. The midway point (around the ear of the user if the article being manufactured is hemisphere for use around the top of the head) is the point at which bunching, or deformation of the cross-section of the parallel conjoined tubes is most prevalent. By only having this additional tension at this spot this tendency can be mitigated (or partially mitigated).

Optionally, further comprising, prior to constraining an edge of the material, positioning the material either: on top of the frame element; underneath the frame element; on top of the mould; underneath the mould. This allows the material to be positioned between the frame element and the mould prior to shaping.

Optionally, further comprising pushing at least a portion of the material at least partially through the cut-out in the frame, wherein the edge of the portion of the material being shaped is restrained by the frame element as the portion of the material is pushed through the cut-out. This enables the edge, or edge region, to be kept in contact with the frame element and to therefore shape the rest of the material, as the remainder of the material is pushed by the mould.

Optionally, further comprising removing the material outside the edge of the portion of the material being shaped. This may enable any lip created to be removed to arrive at the end intended shape.

Optionally, further comprising forming a score mark on the outer surface of the article. This may be used for positioning the element within a helmet, or cutting the article at a predefined point, or to mate with an element of the helmet.

Optionally, the frame comprises a scoring member, and further comprising the step of the scoring member scoring the outer surface of the article as the material is shaped.

Optionally, the frame comprises a second forming element situated at an angle to the first forming element and configured to form the material in a different plane to the first forming element. This may allow complex shapes (such as a “hump” akin to the hump of a camel) to be formed in the material. Optionally, the frame element is a flexible member, such as an inflatable member. This may be highly advantageous as this may allow the restraint of the edge or edge region of the material to be controlled and changed during the shaping as required.

Optionally, the flexible/inflatable member is a torus when inflated with a void in the centre of the flexible or inflatable member. This may allow the void to act as a cutout.

Optionally, further comprising, prior to constraining an edge of the material, positioning the material on top of, or underneath, the flexible/inflatable member.

Optionally further comprising pushing at least a portion of the material at least partially through the void in the centre of the flexible/inflatable member, wherein the edge of the portion of the material being shaped is restrained by the flexible/inflatable member. This may allow a set edge, or edge region to be in perpetual contact with the inflatable member whilst the material is pushed through the void. This may enable the edge or edge region to have a large amount of force provided by the inflatable member, thereby allowing the material to be shaped effectively.

Optionally, further comprising expanding the flexible/inflatable member after the material has been at least partially shaped, and optionally further comprising continuing to shape the material after the flexible/inflatable member has been expanded. This may allow complex geometries to be created with multiple curves, or edges.

Optionally, wherein the flexible/inflatable member is expanded around the side wall of the material to constrain the edge of the material within the frame. This may allow for smaller articles to be shaped with less material wastage.

Optionally, the flexible/inflatable member being expanded reduces the diameter of the void within the flexible/inflatable member. This may therefore increase the curvature of the shaped material.

Optionally, the mould contacting the material shapes the material, and all of the material is shaped.

Optionally, further comprising a first or second step of pre-cutting the material to a desired planar shape, such as a triangular shape. For example a block may be cut into a plurality of triangular portions. Each of these may be used to create a smaller article with little or no material wastage. Optionally, further comprising reducing the cross sectional area of the material as the material is shaped by the mould. For example, as curvature is induced into the material the cross sectional area will lower in size.

Optionally, the flexible/inflatable member is bulbous in the middle such that the crosssection of the void is larger at the top/bottom than the middle of the flexible/inflatable member. This may allow a complex shape to be produced as the effective size of the cut out changes through the shaping process.

Optionally, further comprising moving the material from the top/bottom of the void towards the bulbous centre of the inflatable member as the material is shaped.

Optionally, throughout the movement of the material the edge of the material remains constrained by the flexible/inflatable member. This allows the force to be concentrated on the edge during the entire shaping process.

Optionally, the frame element is a funnel with a decreasing cross-sectional area, for example the top comprises a central void with a first cross sectional area, and below the top the cross sectional area of the void is decreased. This may allow complex shapes to be formed form the material as the cross section of the cut-out effectively changes through the shaping process.

Optionally the funnel comprises side walls with a surface roughness of between 0.025 Ra and 25 Ra. This may advantageously reduce the drag on the material (as compared to a higher roughness) which may reduce deformations in the material. Additionally, this roughness may ensure sufficient shaping is achieved (as compared to lower roughness which may lead to little or no shaping).

Optionally, further comprising shaping the material as the mould contacts the material, thereby reducing the cross-section area of the material.

Optionally, further comprising the material descending through the funnel as the cross-sectional area of the material decreases.

Optionally, as the material descends into the funnel it is further shaped by the mould, until the material either exits the funnel or a desired cross sectional area of the material is reached. This may allow the process to efficiently form shapes that would otherwise take a considerable amount of time.

Optionally, prior to the method the material comprises a plurality of hollow parallel conjoined tubes. This may provide the material with a honeycomb like structure that is suitable for absorbing energy from impacts. Optionally, the material comprises a first surface and a second surface connected via the parallel conjoined tubes.

Optionally, further comprising positioning the material on a compressible block prior to heating, such that the material is heated through the compressible block. The compressible block may be a foam that allow hot air to pass therethrough. This may allow the material to be heated on the block and directly transferred to the moulding site. This may minimise the time for the entire process, and therefore increase the number of articles that may be manufactured in any given time period.

Optionally, positioning the material on the compressible block between the mould and the frame element, such that the compressible block is retained between the frame element and the mould. This may prohibit the frame element from directly contacting the material, but the frame element may still provide the restraint through the compressible block. Any tension the compressible block provides across the surface of the material may be minimal because the block will be in compression from the mould in the shaping phase.

Optionally, further comprising positioning the first surface closer to the heating source, and wherein the mould contacts the second surface. This may allow the first surface to be more malleable (as it is hotter) and the surface opposite the surface contacting the mould is shaped to a greater degree.

Optionally, the first surface is at a higher temperature than the second surface.

In accordance with a second aspect of the invention there is provided an apparatus for thermoforming an article from a material, the apparatus comprising: a heating source; a frame; a mould; wherein the frame element is configured to restrict an edge or region of the material within a frame element; wherein the mould is configured to move towards the frame, or vice versa, such that the material is in contact with the mould. This apparatus may allow articles to be shaped that more closely correspond to the intended shape, or that retain a greater amount of the impact reduction properties of the material. Fewer articles may be discarded due to failing quality control testing as a result of using this apparatus. Optionally, the frame element is a substantially rigid element. This may allow the force to be transmitted to the edge portion of the material and for this to effectively shape the material as desired.

Optionally, the frame element contains a cut-out. This may allow the material to be pushed therethrough to aid with shaping.

Optionally, this is located in the centre of the frame element. This may allow for an entire perimeter of the cut-out to contact the edge of the material.

Optionally, the shape of the cut-out corresponds to the cross-sectional shape of the mould. This may (with any pre-cutting if required) allow the desired shape of the eventual article to be readily and simply made.

Optionally, the frame element extends down by between 5 mm-20 mm, and preferably 6 mm-12 mm. This extension down (i.e. perpendicular to the plane in which the cutout is in) may provide additional tension to the material as it is pushed through the cut-out. This may stop the deformation of the cross sectional shape of any of the conjoined parallel tubes. These particular measurements of extensions have been found to minimise these deformation patterns.

Optionally, the extension down is positioned at a midway point in the longitudinal direction of the cut-out of the frame. The midway point (around the ear of the user if the article being manufactured is a hemisphere for use around the top of the head) is the point at which bunching, or deformation of the cross-section of the parallel conjoined tubes is most prevalent. By only having this additional tension at this spot this tendency can be mitigated (or partially mitigated).

Optionally, further comprising a compressible block configured to be positioned between the frame element and the material prior to the mould moving towards the frame. This may allow the material to be transferred and moulded without touching the material (simply moving the block) which may be advantageous.

Optionally, the frame comprises a second forming element situated at an angle to the first forming element and configured to form the material in a different plane to the first forming element. This may allow complex shapes to be formed.

Optionally, the frame element is a flexible member, such as an inflatable member. This may allow complex shapes to be formed. Optionally, the flexible/inflatable member is a torus when inflated with a void in the centre of the flexible or inflatable member. This may allow the void to function as a cut-out.

Optionally, the flexible/inflatable member is bulbous in the middle such that the crosssection of the void is larger at the top/bottom than the middle of the flexible/inflatable member. This may allow the shaping of the material to change as it moves through the member.

Optionally, the frame element is a funnel with a decreasing cross-sectional area, for example the top comprises a central void with a first cross sectional area, and below the top the cross sectional area of the void is decreased.

Optionally, the material comprises a plurality of hollow parallel conjoined tubes. This may allow the material to have honeycomb like properties.

Optionally, the apparatus is configured to perform the method of the first aspect.

Optionally, the heating source is a hot air source. Alternatively, the heat source is an infrared light source, or other lamp used for heating.

In accordance with a third aspect of the invention is a product produced from the material to form protective equipment. Optionally this may be produced using the method steps of the first aspect. Optionally this may be personal protective equipment such as a helmet.

Optionally this may be a car part to improve the safety of crumple zones. This may be produced in any manner. Optionally this may be produced with the method of the first aspect. This may have a thickness of in excess of 5 cm, and optionally in excess of 10 cm.

In accordance with a third aspect of the invention there is described a frame. The frame is in accordance with the frame of the second aspect. The frame may have the same optional features as the second aspect.

### BRIEF DESCRIPTION OF DRAWINGS

FIG. 1 shows a material with a honeycomb like structure, optionally formed from parallel conjoined tubes.

FIG. 2 shows a heating plate for heating the material.

FIG. 3 shows a second embodiment of a heating plate.

FIG. 4 shows the material positioned on the heating plate.

FIG. 5 shows a pre-cut portion of material positioned on the heating plate.

FIG. 6 shows the material and heating plate being positioned within a heating system.

FIG. 7 shows the heating plate and material within the heating system.

FIG. 8 shows a cross section of the material within the heating system.

FIG. 9 indicates the direction of hot air flow in the cross section of FIG. 8.

FIG. 10 shows the mould and a frame element in accordance with one embodiment.

FIG. 11 shows the mould and frame element of FIG. 10 with the material positioned in between.

FIG. 12 shows the mould and the frame element, with the material and the heating plate positioned in between.

FIG. 13 shows the mould and frame element of FIG. 10 with the material positioned in between.

FIG. 14 shows the mould being lowered to make contact with the material such that the mould and the frame element shape the material.

FIG. 15 shows the material in the frame element after shaping.

FIG. 16 shows a block of material after the same shaping process.

FIGS. 17a-17e show three stages in the shaping of the material in embodiments in which the size of the cut-out in the frame element is tapered with depth.

FIGS. 18a-18d show four stages in the shaping of the material in embodiments in which the size of the cut-out is constant (as shown here for example the frame element may be substantially thin, for instance with a depth of less than 2 cm, or in some instances less than 5 mm).

FIG. 19 shows a mould and a frame element wherein the frame element is formed from a flexible or inflatable member.

FIG. 20 shows the mould and frame of FIG. 19, with the material placed in between.

FIG. 21 shows the mould moved towards the frame element so as to shape the material.

FIG. 22 shows the shaped material and the frame element after the process of FIG. 21.

FIG. 23 shows a pre-cut portion of material in between the frame and mould of FIG. 19.

FIG. 24 shows the material of FIG. 23 shaped in the inflatable frame element.

FIG. 25 shows an embodiment in which material is positioned between a mould and a frame element in accordance with a third embodiment, in which the frame element is shaped like a funnel with a cut-out cross sectional area that decreases with increasing depth of the frame element.

FIG. 26 shows a mould and a compressible block. The compressible block may be used in place of a frame element, or in conjunction with a frame element. The compressible block may also be used in place of a heating plate.

FIG. 27 shows the mould and compressible block of FIG. 26, with pre-cut material position in between the compressible block and the mould.

FIG. 28 shows the mould and compressible block of FIG. 26, with a block of material position in between the compressible block and the mould.

FIG. 29 shows the elements of FIG. 28, where the mould has been moved to contact and shape the material. In practice, the block may be compressed.

FIG. 30 shows a shaped block of material after the step shown in FIG. 29.

FIG. 31 shows a shaped pre-cut portion of material on the compressible block.

FIG. 32 shows a flow chart outlining one method of use of the apparatus shown above.

FIGS. 33a and 33b shows an apparatus for performing shaping of multiple portions of material at the same time. FIG. 33a is a perspective exploded view from above, and FIG. 33b is a perspective exploded view from below.

FIG. 34a shows a heating plate with multiple portions of material about to be positioned between a frame element with multiple cut-outs, and a mould with multiple moulding portions. FIG. 34b shows the heating plate in position between the frame element and mould of FIG. 34a.

FIG. 35a shows the mould portions brought into contact with the portions of material to result in shaping of the material.

FIG. 35b then shows the mould retracted after shaping.

FIG. 36a shows the mould and the multiple portions of shaped material.

FIG. 36b shows the shaped material on the heating plate between the frame element and the mould.

FIG. 37 is a view of the frame element with multiple cut-out portions.

FIG. 38a shows the profile of an article to be manufactured

FIG. 38b shows two such articles arranged next to each other (a left and right side)

FIG. 38c shows a profile of a single article that may be used to form the two halves shown in FIG. 38b.

FIG. 39a shows a three dimensional view of a single article.

FIGS. 39b and c show a three dimensional view of an article combining a left and right side (as shown in FIG. 38c).

FIGS. 39d and e show the splitting and trimming of the article of FIGS. 39b and 39c, to reach the articles of FIG. 39a.

FIG. 40a shows a starting position of an alternative forming method in which the mould is placed above the material, with the frame situated under the material, and with the bottom of the frame bounded into a bowl or well.

FIG. 40b shows the apparatus of FIG. 40a, but at a later stage of the forming process as the mould begins to contact the material and push the material through the frame.

FIG. 40c shows the same apparatus as FIGS. 40a and 40b, but at the end of the process with the material moulded by the frame, and with the material situated at least partially within the bowl or well of the frame.

### DETAILED DESCRIPTION

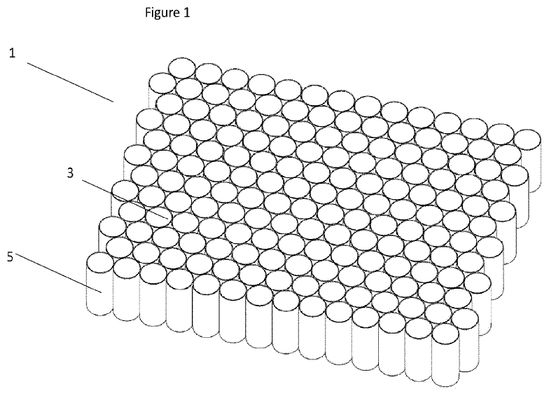

FIG. 1 shows a material 1 with a honeycomb like structure, optionally formed from parallel conjoined tubes 5. This material is very strong, and can absorb a large amount of energy associated with impacts that impact the face of the block (i.e. the open ends of the tubes 3). Whilst strong in this direction the tubes may be pulled apart with relatively little force. Therefore, the material must be shaped for use so that the face of the block 3 would be expected to bear the brunt of any impacts during use.

The material for example may be used in personal protective clothing, such as helmets, kneepads, elbow pads and the like. Should a person wearing a helmet fall off of their bike for instance, then the aim is for the material to deform and this deformation to absorb a great deal of the energy associated with the impact. This therefore reduces the likelihood of the user sustaining a serious injury.

In order to form usable protective equipment the block may be cut, and/or thermoformed to create articles of such equipment.

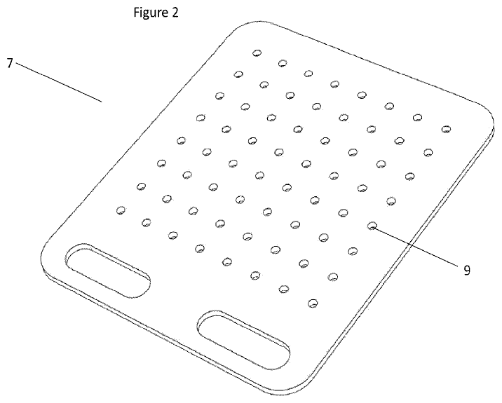

FIG. 2 shows a heating plate 7 for heating the material. This may be used such that the block of material 1 shown in FIG. 1 sits on top of the face of the plate.

The plate comprises a plurality of holes 9 to allow hot air to pass through the plate 7 in order to heat the material.

The plate 7 may be formed of any suitable material that is configured to withstand a high heat. For example the plate may be formed from ceramic, metal, some polymers, treated wood, or the like. The temperatures used to heat the material are typically between 100 degrees Celsius and 200 degrees Celsius.

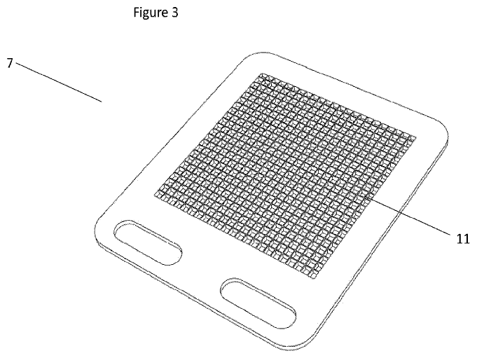

FIG. 3 shows a second embodiment of a heating plate 7. This is similar to the first heating plate 7 of FIG. 2. Rather than holes 9 in a material there is instead fitted into the heating plate a gauze 11, or gauze like device. This may allow a greater flow of hot air through the heating plate.

In some embodiments the gauze 11 may be compressible, or flexible. This may allow the heating plate to be situated between the mould and the frame element during the shaping process. This lack of removal of the heating plate may speed up manufacture in some embodiments.

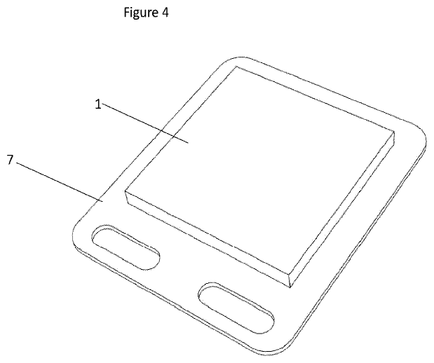

The gauze 11 would not provide any meaningful tension to the surface of the material during shaping in such embodiments. This may prevent unwanted deformation or damage to the surface of the material. FIG. 4 shows the material 1 positioned on the heating plate 7. This shows an entire uncut block of material 1 positioned over the air flow portion (the holes) of the heating plate.

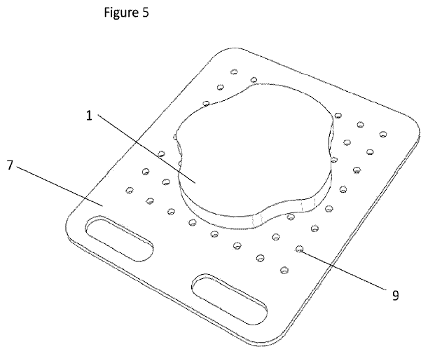

FIG. 5 shows a pre-cut portion of material 1 positioned on the heating plate 7. This shows a pre-cut portion of material 1 (it may be cut to any size or shape dependent on the article required). The portion of material 1 is situated over the air flow portion with the holes 9.

FIGS. 4 and 5 show the first heating plate 7 in use, but in other embodiments the second heating plate may equally be used.

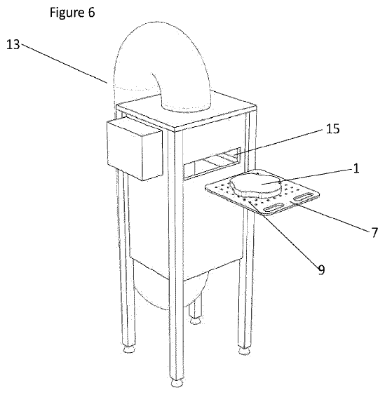

FIG. 6 shows the material 1 and heating plate 7 being positioned within a heating system 13. This shows that the heating system 13 has an entry slot 15 configured to accept the heating plate 7 and material 1. The heating plate 7 is about to be entered into the heating system 13 through this slot 15.

Hot air will then be blown from below the material 1, through the heating plate 7, such that the underside of the material 1 is heated to a greater extent than the top surface of the material.

It is noted that any suitable heating method may be used. For example, lamps may be used to heat the material such as infrared lamps, or the material 1 may be submerged in a liquid that is heated to a set temperature.

FIG. 7 shows the heating plate 7 and material 1 within the heating system. This shows the material 1 and the heating plate 7 in the path of the air flow, and the plane of the heating plate 7 and the material 1 is perpendicular to the air flow path.

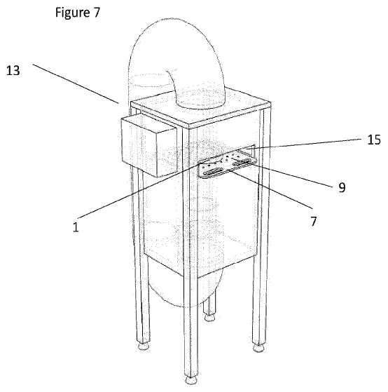

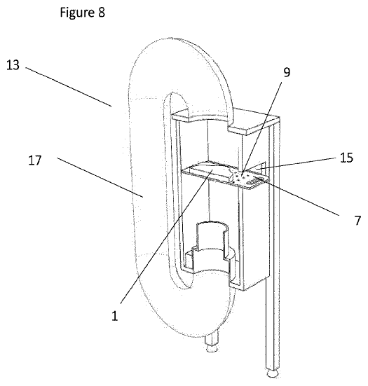

FIG. 8 shows a cross section of the material 1 within the heating system 13. This shows that the air flow path circulates air flow. The air flow is driven up through the material 1, and then is heated when it is in the heating chamber 17.

FIG. 9 indicates the direction of hot air flow in the cross section of FIG. 8. This shows both the direction of air flow (anti-clockwise from this view, and up through the material 1 and the heating plate 7) and the location of the heating elements 17 that heat the air flow within the heating chamber 17.

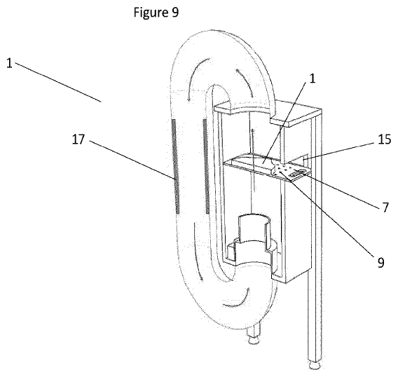

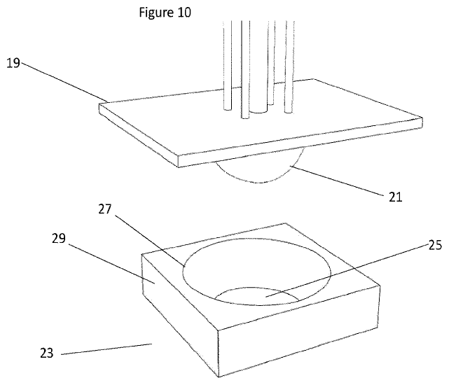

FIG. 10 shows portions of an apparatus for thermoforming an article from a material. The apparatus comprising a heating source (optionally as shown in FIGS. 6-9) a frame 23, a mould 19 comprising a moulding element 21, wherein the frame element 23 is configured to restrict an edge or region of the material 1 within a frame element, wherein the mould 19 is configured to move towards the frame 23, or vice versa, such that the material 1 is in contact with the mould 19/21.

FIG. 10 shows the mould 19 and a frame element 23 in accordance with one embodiment. In general terms the frame element 23 comprises a body 29 and a cutout 25.

The frame element 23 may be any suitable frame element. The frame element 23 is configured to restrain the edge, or an edge region as the mould pushes the material through the cut-out 25 in the frame element. The edge of the material 1 is restrained so that there is an unequal force applied over the area of the material 1. In particular the top surface 3 does not receive an approximately equal force across the entire surface area. Instead, the frame element 23 concentrates applying force to the edge or edge region of the material 1 only. The frame element 23 applies the majority of force through the edge 27. If the material is pushed further through the cut-out 25 the force may be provided by the plane of the surface within the cut-out.

The mould 21 is any suitable mould that approximates to the shape of the article that is being produced. It is configured to be moved down through the cut-out 25 of the frame element 23. However, in other embodiments the frame element 23 may be brought up around the mould 21.

This specific frame element 23 has a depth, of at least 20 mm, and optionally in the range of 20 mm to 250 mm. This creates a funnel portion within the cut-out 25. There may be a further un-tapered portion below the funnel. The cut-out 25 changes radius with depth in this embodiment. This means that the frame element 23 acts as a funnel. In this embodiment, the frame element 23 is substantially rigid.

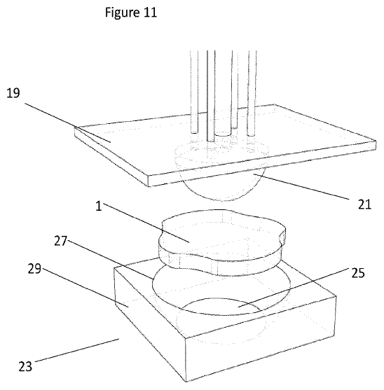

FIG. 11 shows the mould 21 and frame element 23 of FIG. 10 with the material 1 positioned in between. The material 1 in this Figure is shown as being pre-cut to a pre-defined shape.

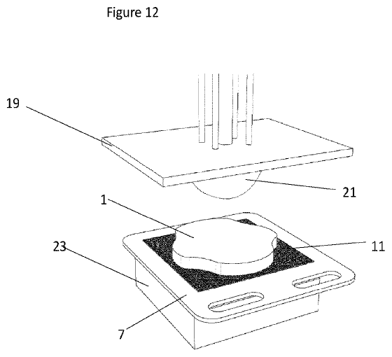

FIG. 12 shows the mould 21 and the frame element 23, with the material 1 and the heating plate 7 positioned in between.

The heating plate 7 in this example may comprise a gauze 11 that is substantially flexible or compressible. Therefore this allows for the material 1 to be heated on the heating plate 7, and directly transferred from the heating means 13 to the shaping means (the mould 21 and frame element 23 combination). There is no need to remove the heating plate 7 in this embodiment. This may mean that the material 1 is handled less—especially whilst it is hot, and therefore there is less chance of breakages occurring. This also removes the need to remove the heating plate 7 during the manufacture process, and so may increase the speed at which the article may be manufactured.

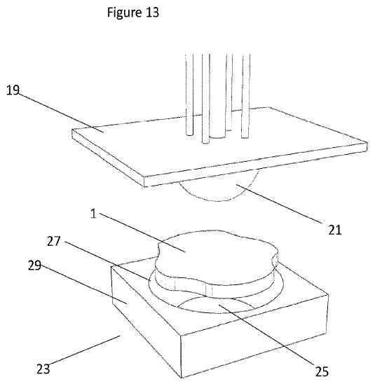

FIG. 13 shows the mould 21 and frame element 23 of FIG. 10 with the material positioned in between. Again in this embodiment the material 1 is shown as being pre-cut.

FIG. 14 shows the mould 21 being lowered to make contact with the material 1 such that the mould 21 and the frame element 23 shape the material 1.

The mould 21 may be lowered by any suitable means, such as hydraulic, pneumatic or the like.

The mould 21 is shown pushing the material 1 through the cut out 25 in the frame element 23. The edge, or edge region of the material 1 maintains contact with the edge 27 of the cut-out 25 of the frame element 23 at all times. This restrains the edge or edge region of the material 1 throughout the shaping process. This means that the portion of the material within the edge is shaped by the mould 21, whilst the portion in contact with the edge is approximately stationary. The portion outside of the edge does not shape (or does not shape in line with the shape of the mould 21). For pre-cut portions of material 1 the edge may correspond with the edge of the material itself. For blocks of material 1 the edge is likely to be along the front face of the block.

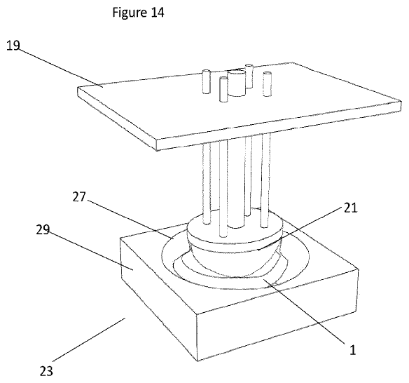

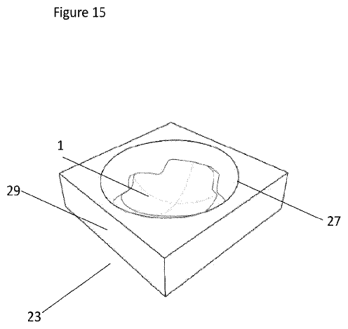

FIG. 15 shows the material 1 in the frame element 23 after shaping. This shows the induced curvature in the material 1. For example, this may correspond to an inner layer of a helmet such as a bicycle helmet or snow sports helmet.

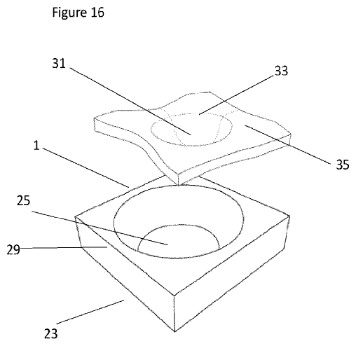

FIG. 16 shows a non-pre-cut material 1 after the same shaping process. This shows very clearly where the edge 33 that was restrained by the frame element 23 lies. This also shows the unshaped surrounding portion 35 and the shaped article 31 within. The unshaped portion 35 may be removed before the article is complete.

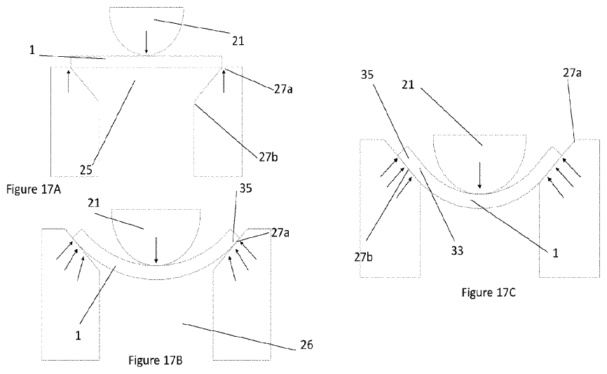

FIGS. 17a-17e show five stages in the shaping of the material in embodiments in which the size of the cut-out 25 in the frame element 23 is tapered with depth (although the last two stages may be omitted). This is shown in cross section. In these Figures, the frame element 23 is a funnel type of frame element. Additionally, in this embodiment the funnel comprises a further non-tapered portion 26. This nontapered portion is entirely optional. In FIG. 17a the material 1 overlies the cut-out 25 of the frame element 23. The mould 21 is positioned above the material. No shaping has yet occurred.

In FIG. 17b the mould 21 is brought into contact with the material 1 and is pushing the material 1 through the cut-out 25 of the frame element. The material 1 is being shaped and is bowing.

The edge is the portion of the material 1 in contact with the edge 27 of the cut-out 25 of the frame element 23.

FIG. 17c shows that as the mould 21 continues to push the material through the cut-out 25 of the frame element 23 the material 1, and in particular the edge portion 33 moves down the funnel of the frame element. This changes exactly where the edge of the frame element 27 contacts the material 1 (moving the edge region 33 of the material inwards towards the centre of the material as the material descends through the funnel) and so changes the portion of the material that is being shaped. This creates a compound curve as shown. The central portion continues to be shaped—but outside 35 of the shaping portion there is a linear shape. This can result in less of the material having to be discarded, and can result in steeper curves (known as deeper draws) than can otherwise be produced.

For embodiments that only make use of a funnel and not additional linear portion 26 the method may stop here.

FIG. 17d shows the material 1 being pushed into the section of the funnel with constant cross-section 26. The linearly shaped portion 35 is shown as being outside of the shaping edge 33. However, as the material continues to be pushed into the section of constant cross section 26 the edge of the shaping region 33 moves outwards until all or at least a desired amount, of the material 1 is shaped.

FIG. 17e shows that the material 1 has completely entered the constant cross section portion of the funnel 26. At this stage the entirety of the material 1 is shaped

Therefor this combination of the funnel and constant cross section second stage may create an efficient shaping means that minimises wasted material, whilst maximising the angle that may be created by shaping.

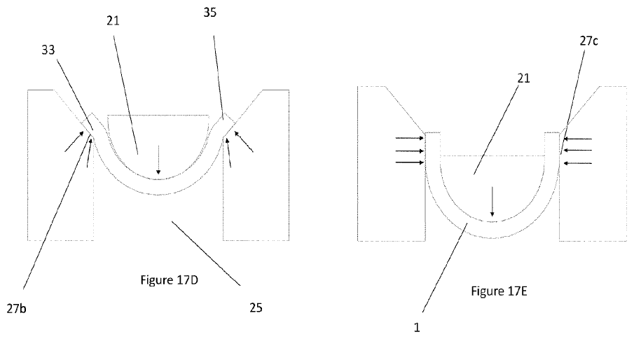

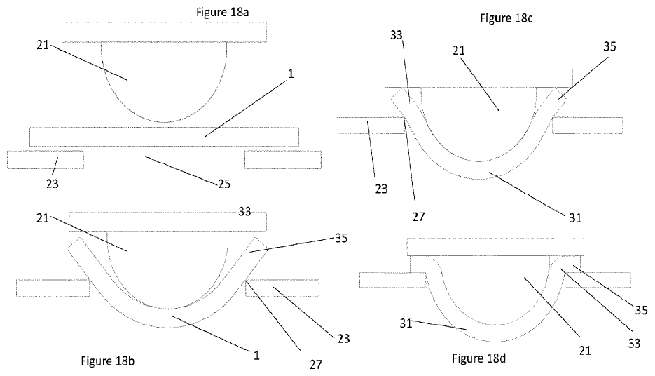

FIGS. 18a-18d show four stages in the shaping of the material in embodiments in which the size of the cut-out 25 is constant (as shown here for example the frame element 23 may be substantially thin). In FIG. 18a the material 1 overlies the cut-out 25 of the frame element 23. The mould 21 is positioned above the material 1.

In FIG. 18b the mould 21 is brought into contact with the material 1 and is pushing the material 1 through the cut-out 25 of the frame element 23. The material 1 is being shaped and is bowing. The portion of material outside 35 of the edge region 33 is not being shaped.

The edge 33 is the portion of the material in contact with the edge 27 of the cut-out 25 of the frame element 23.

In FIG. 18c the material has been forced further through the cut-out 25. Therefore the shaped region 31 has been further shaped. The area outside of the shaping region is unshaped region 35. This may come into contact with the mould. The edge 33 of the material is in substantially the same location along the material in FIGS. 18b and 18c.

FIG. 18d shows that as the mould 21 is pushed all the way through the cut-out 25 of the frame element 23 the position of the edge 33 of the material 1 that is restrained by the frame element 23 stays approximately constant. There can be minor slippage as additional material is brought into the region being shaped (which can lead to some minor warping) but this is minimised by slowing the pushing of the mould 21 through the cut-out 25.

It is noted, that the non-shaping part of the mould may push the non-shaped region 35 against the top of the frame element 23. Therefore the angle at the edge 33 between the shaped region 31 and the unshaped region 35 is significant.

Therefore, in this embodiment the draw can be less deep than the draw of the funnel type frame element embodiment. However, both provide efficient manufacture of a variety of types of thermoformed articles from the material in question. The thin type of frame may also have less breakages, or discarded articles than the funnel embodiment. The draw is still deeper than that produced using the membrane method described in the background section. Moreover, the shaped article may be closer to the intended shape.

It is noted that the frame element 23 may comprise further features. For example, the substantially thin frame element 23 may comprise portions at which the depth of the frame element is increased. For example around the midway position of the cutout of the frame element the depth of the frame element may be increased by 5-20 mm, and preferably between 6 mm and 12 mm. This may provide additional tension and force against this portion of the edge of the material being shaped. As the midway point is a point at which there has been found to be more deformation due to shaping, this increase in depth can mitigate, or partially mitigate such deformation at this position. For a hemispheric helmet portion this would be just above where the ears of the user are positioned.

Another optional further feature of the frame element 23 may be a second frame element positioned at an angle to the plane of the cut-out of the first frame element. For example the second frame element may be perpendicular to this plane. This may allow complex shapes, such as a hump or lump to be created, or for their to be numerous peaks and troughs. In some embodiments the second frame element may comprise a scoring element and may be positioned such that when fully shaped the material just touches the scoring element. This may deform the outer surface of the material slightly without re-shaping the material. This may create a score mark that can used for showing where cuts take place, or for fitting the article into other objects that have protuberances and the like.

FIG. 19 shows a mould 21 and a frame element 23 wherein the frame element 23 is formed from a flexible or inflatable member. This shows the rigid frame element replaced by a tyre-like structure. This may be formed of rubber or another elastomeric material such as silicone or the like. This may stretch as the frame element is inflated, or otherwise expanded/stretched.

The frame element 41 is shown on a stand 45 for stability but this is entirely optional.

The cut-out is instead a void 43 in the centre of the frame element. The frame element 41 is shaped as a torus to produce this void 43.

The void 43 may be shaped depending on the shape of the frame element 41. For example in some embodiments the void will be approximately cylindrical so that the cross sectional area of the void does not change with the depth of the frame element. In other embodiments the centre of the frame element 41 may bulge so that a funnel type of frame element 41 is produced.

Smaller inflatable members may be used as frame elements 41 to inflate around the side of the material (especially pre-cut smaller portions). This may restrain the side of the material as the mould 21 is pushed through the void. This may only allow for relatively shallow shaping of the material, but for small portions (e.g. elbow pads, or portions to be inserted at key points in a helmet, but that do not constitute an entire continuous layer of helmet) this may be desirable as it minimises wastage. In such embodiments pre-cutting the block of material 1 into triangular portions may lead to very little wastage pre-shaping. The triangular portions may be shaped as per above using the smaller inflatable members inflated around the side edge of the material, and this may further reduce the wastage of material. These triangular members may be used for inserts into portions of a cycling helmet.

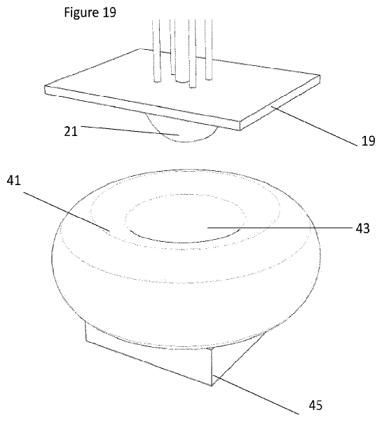

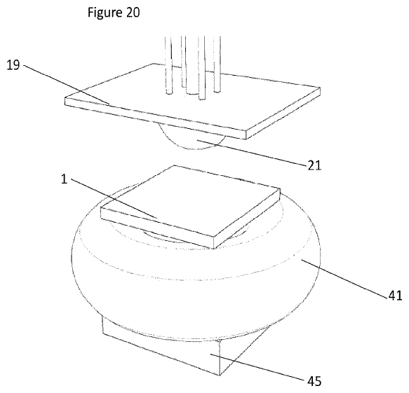

FIG. 20 shows the mould 21 and frame 41 of FIG. 19, with the material 1 placed in between.

The material 1 shown in this Figure is an entire block that is not pre-cut. Pre-cut material portions 1 may instead by used.

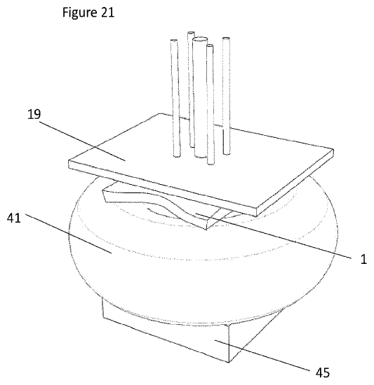

FIG. 21 shows the mould 21 moved towards the frame element 41 so as to shape the material 1.

The material 1 within the edge 33 region is shaped by the mould through void.

The outer material 35 is essentially unshaped (there may be a small amount of crumpling as shown).

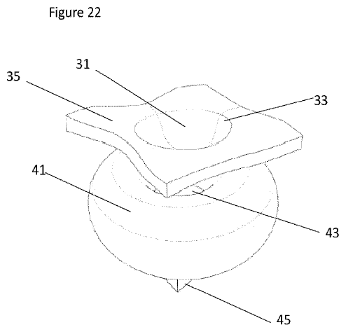

FIG. 22 shows the shaped material 31 and the frame element 41 after the process of FIG. 21.

This shows that the portion of the material within the edge 33 of the material that is restrained by the frame element is shaped 31. The outer portion 35 is substantially unshaped. This outer portion 35 may be removed as wastage before the article is complete.

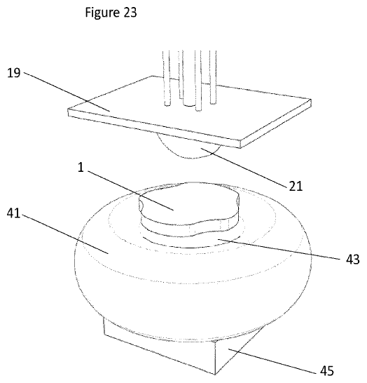

FIG. 23 shows a pre-cut portion of material 1 in between the frame 41 and mould 21 of FIG. 19.

The same process is then repeated—but this time on the pre-cut portion of material, rather than the entire block of material as previously shown.

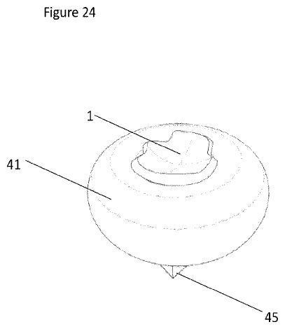

FIG. 24 shows the material 1 of FIG. 23 shaped in the inflatable frame element 41. This shows that the entire portion of pre-cut material 1 has been shaped to reach the article as intended.

It is dependent on the article and the shapes/dimensions involved whether pre-cutting or cutting post shaping results in less wasted material.

It is noted that during the shaping process for embodiments in which the frame element is an inflatable member 41, the inflatable member may be inflated/deflated. This may change the cross-sectional area of the void 43 (i.e. inflation would reduce this, deflation would enlarge this), as well as the force provided on the edge portion of the material 33. This may allow for complex shapes to be produced. For example, inflation during shaping may allow a deeper draw to be created.

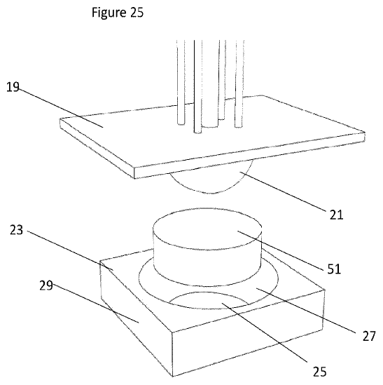

FIG. 25 shows an embodiment in which material 1 is positioned between a mould 21 and a frame element 23 in accordance with a third embodiment, in which the frame element 23 is shaped like a funnel with a cut-out 25 cross sectional area that decreases with increasing depth 29 of the frame element 23.

It is noted that the side walls 27 of the funnel may have an optimal surface roughness. If the surface roughness of the side walls 27 is too low then the amount of shaping may be reduced, and so the desired shape may not be achieved. In some examples, plastic sheets with a silicone spray may be too smooth for sufficient shaping. If the surface is too rough then there may be deformations of the material that are not warranted. Unfinished of unvarnished MDF may for example be considered too rough in some embodiments. A surface roughness of between 0.025 Ra and 25 Ra may be sufficient for ideal shaping to occur.

The material 1 in this example may also have an enlarged thickness which may reduce the extent to which the material can be shaped. This may be used for alternative uses such as car parts of the like in order to increase the safety of crumple zones.

FIG. 26 shows a mould 21 and a compressible block 61. The compressible block 61 may be used in place of a frame element 23, or in conjunction with a frame element 23. The compressible block 61 may also be used in place of a heating plate 7.

Therefore, the compressible block 61 may be moved from the heating element 13 to the shaping element without the need for removal of the compressible block 61. This may increase the efficiency of the method.

The compressible block 61 may be positioned on top of a frame element 23 and then shaping may commence as detailed above. The block will not interfere with the shaping process. No tension will be applied to the surface of the material 1 by the block as the block is in compression rather than tension.

The compressible block 61 may allow hot air to pass therethrough such that it can be used in place of the heating plate 7. In some instances the compressible block 61 may be formed of a foam, sponge, or similar material.

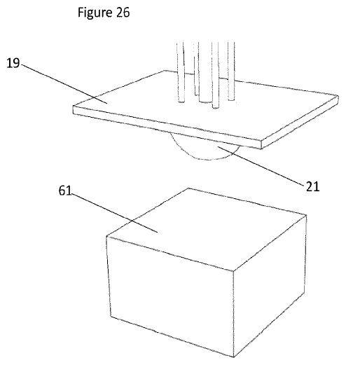

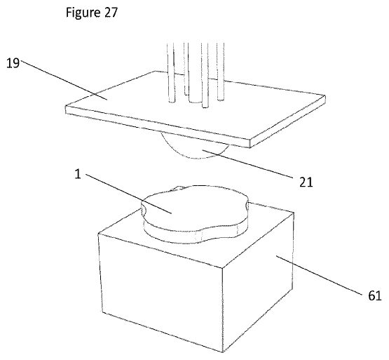

FIG. 27 shows the mould 21 and compressible block 61 of FIG. 26, with pre-cut material 1 positioned in between the compressible block and the mould. In this example no frame element is used. Therefore the mould 21 is to be moved into contact with the material 1, and to then compress the compressible element 61.

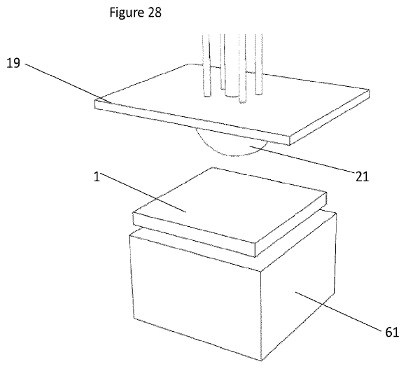

FIG. 28 shows the mould 21 and compressible block 61 of FIG. 26, with a block of material 1 positioned in between the compressible block 61 and the mould 21. This is the same as FIG. 28—but with a full block instead of a pre-cut portion of material 1.

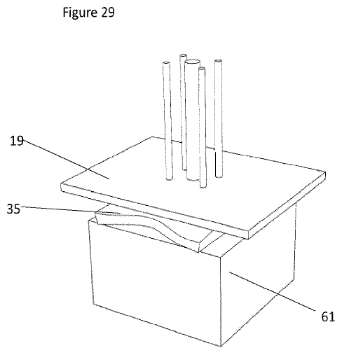

FIG. 29 shows the elements of FIG. 28, where the mould 21 has been moved to contact and shape the material 1. In practice the block 61 may be compressed at least partially as the material is shaped.

FIG. 30 shows a shaped block of material 1 after the step shown in FIG. 29. This is substantially the same as the shaped material shown above.

FIG. 31 shows a shaped pre-cut portion of material on the compressible block 61. This is the result of shaping of the arrangement shown in FIG. 28.

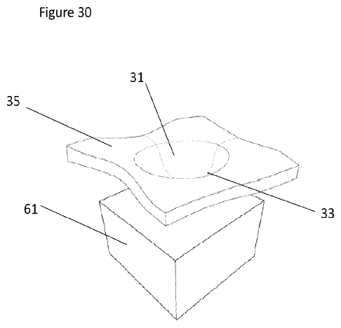

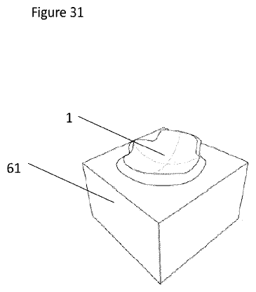

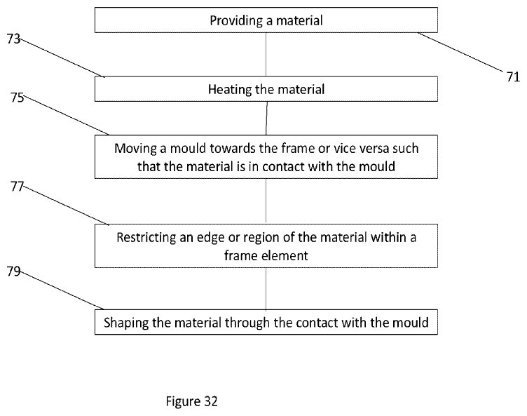

FIG. 32 shows a flow chart outlining one method of use of the apparatus shown above. This comprises the first step of first providing a material 71. This may be in any form, for example an entire block of material, or a pre-cut portion. The material may be any honeycomb like material, or may be the material shown in FIG. 1 formed from parallel conjoined tubes.

The next step may comprise heating the material 73. This heating may be done in any way. For example, a liquid bath, such as a water bath, may be used. Alternatively lamps may be used, or hot air may be used and blown through the material. This may be the preferred method of heating, and one preferable way of doing so is shown in FIGS. 4-9.

The next step comprises moving a mould towards the frame, or vice versa, such that the material is in contact with the mould 75. This can done as shown in any of FIGS. 10 to 31. Indeed, there may be a material between the material to be shaped and the mould, such as a cover. This still constitutes the mould contacting the material as it is applying a shaping force thereto.

The next step comprises restricting an edge or edge region of the material within a frame element 77. In practice this may occur simultaneously with the mould contacting the material, or shortly before or thereafter.

The edge may be edge of the portion of the material that is being shaped. For example where an entire block of material is being shaped this is likely to be within the face of the block (as shown for example in FIG. 30). For pre-cut material the edge may be the edge of the front face of the material, or even the side wall of the material. The side wall may be used for particular inflatable frame member embodiments where the shaping is not deep, or the article to be produced is small such as an elbow pad or a portion for placement in a helmet.

The final step comprises shaping the material 79, this may in actuality begin as soon as contact with the material is made, or soon thereafter. This comprises pushing the mould through the cut-out of the frame element (at least partially).

An additional step may comprise removing excess wastage material where appropriate.

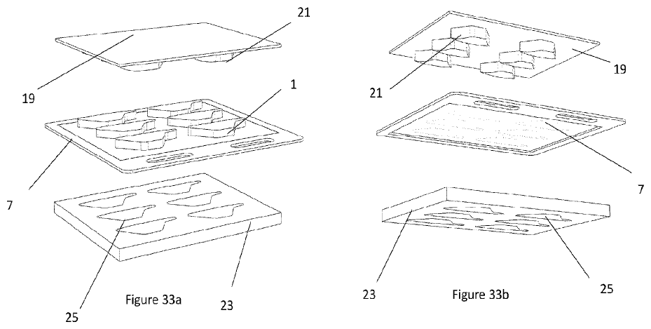

FIG. 33a shows a mould portion 19 comprising multiple moulding elements 21. These may each mould a portion of material simultaneously. This may therefore increase the efficiency of the manufacture process.

Also shown is a frame element 23 with multiple cut-outs 25. Each cut-out may correspond with one of the moulding elements 21.

In the between the frame element 23 and the mould 21 is a heating plate 7 with multiple portions of material 1. It is noted that the heating plate 7 is entirely optional as discussed above in relation to single piece moulding embodiments. The heating plate 7 may however increase the efficiency of the manufacture process. There may be a number of portions of material 1 where said number is equal to the number of cut-outs 25 in the frame element 23.

The portions of material 1, cut-outs 25 in the frame element 23, and mould elements 21 of the mould 19 may be aligned.

FIG. 33b shows the same elements as FIG. 33a. However, the perspective is from below. Therefore the portions of material 1 are not directly visible (except through the heating plate 7).

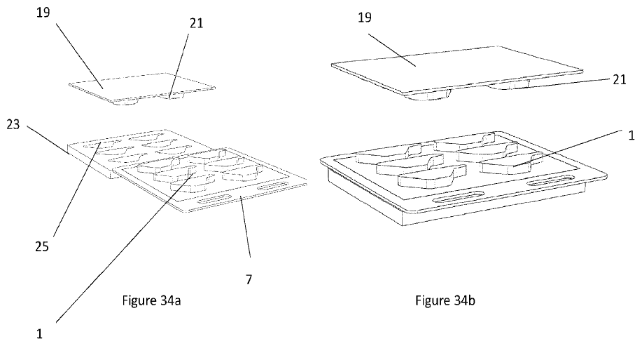

FIG. 34a shows the heating plate 7 about to be positioned between the mould 19 and the frame element 23. In alternative embodiments the portions of material 1 may be directly placed on the frame element 23, and no heating plate 7 may be present.

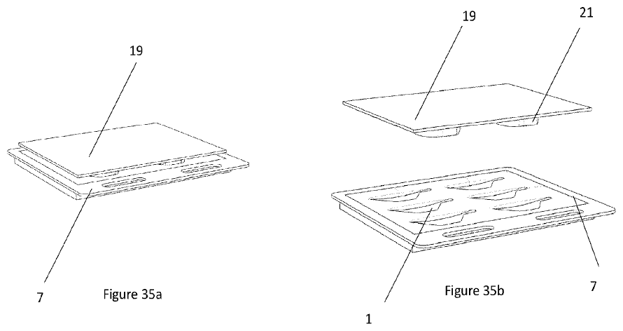

FIG. 34b shows the apparatus just before shaping commences. FIG. 35a shows the mould 19 moved towards the frame element 23 such that at least a portion of the mould elements 21 pass into the cut-outs 25 of the frame element 23. The material 1 is therefore shaped by this motion.

FIG. 35b shows the mould 19 removed from the frame element 23 after shaping of the material 1. The portions of the material 1 are sunken within the cut-outs 25 of the frame element 23.

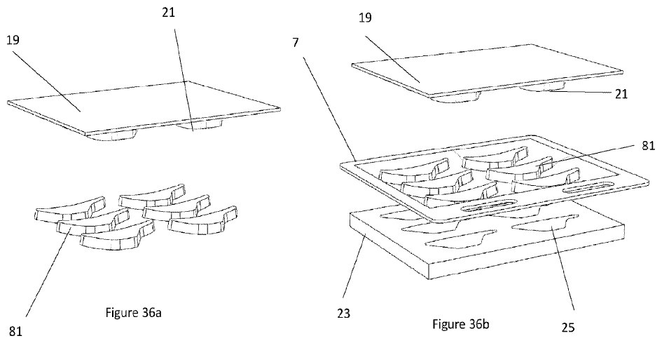

FIG. 36a shows the mould and the shaped portions of material 1. The shaped portions may be whole blocks of material 1 that have been shaped, or as shown, portions of material 1. Such portions are not drawn as deeply as shown in FIGS. 17 and 18.

FIG. 36b shows the shaped material on the heating plate 7 after the material 1 is removed from the frame element 23.

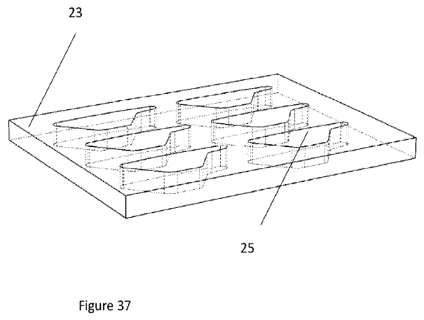

FIG. 37 shows an example of a frame element 23 with multiple cut-outs to enable the manufacture of multiple elements at any one time. The frame element 23 shown comprises cut-outs of constant cross-sectional area. Alternative embodiments may have a frame element 23 with a lower thickness similar to that shown in FIG. 18. Alternatively the frame element 23 may comprise a flexible or inflatable member 41 with multiple voids 43. Alternatively the frame element 23 cut-outs 25 may each comprise funnels. Alternatively, the funnels may terminate in portions of constant cross sectional area 26 as shown in FIG. 17. Alternatively, the frame element 23 cut-outs 25 may comprise a combination of those described above.

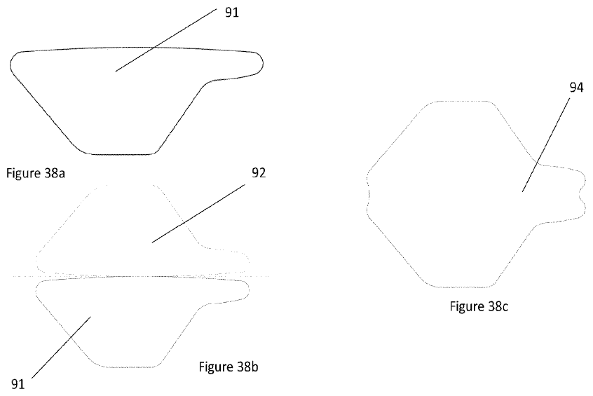

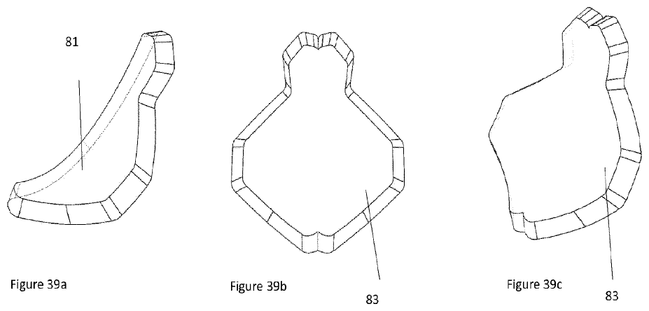

FIG. 38a shows the profile of an article 91 to be manufactured. This may be any shape/size. Typically such an article forms a portion of a helmet, but not a whole hemisphere. It is therefore common to have symmetrical members in opposite sides of a helmet. These are in effect optical isomers of one another (as shown in FIG. 38b). There may be any number of elements, but often there would be an even number. There may be an odd number if there is a left and right portion and a single brow/front portion.

In this example the shape 91 approximates to around half a hemisphere. This profile of this shape is not symmetrical. Whilst this can be made using the methods described above in some instances the lack of symmetry can increase the deformation of the material. Therefore the method described herein enables multiple portions to be manufactured at the same time by making use of mirroring. FIG. 38b shows two such articles 91, 92 arranged next to each other (a left and right side). These are optical isomers of one another. These two portions may be formed from a single piece as shown below.

FIG. 38c shows a profile of a single article 94 that may be used to form the two halves shown in FIG. 38b. This is symmetrical and therefore forming this single element (and then using this to form the two halves) may result in less deformation of the material 1.

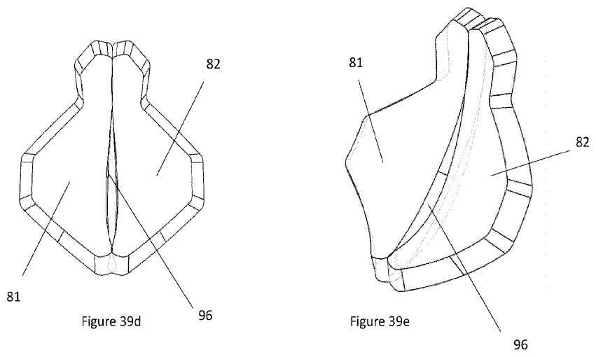

FIG. 39a shows a three dimensional view of a single article 81. This shows one half that may be positioned within a helmet. This is asymmetrical in profile.

FIGS. 39b and c show a three dimensional view of an article 83 combining a left and right side (as shown in FIG. 38c). This is symmetrical in profile along a central longitudinal line.

FIGS. 39d and e show the splitting and trimming of the article 83 of FIGS. 39b and c, to reach the articles of FIG. 39a. The single article may be cut/split along the line of symmetry. This may result in the finished left 81 and right 82 handed articles. In this case there is an extra step of trimming the inner profile of the resulting shapes to conform with the required shape of the helmet. The removed material is shown by placing the two halves next to one another to illustrate the missing material 96.

This trimming may be performed in any suitable way such as using a planning tool, a sander, or using cutting means.

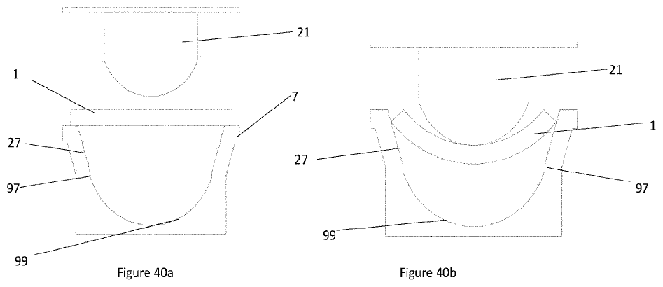

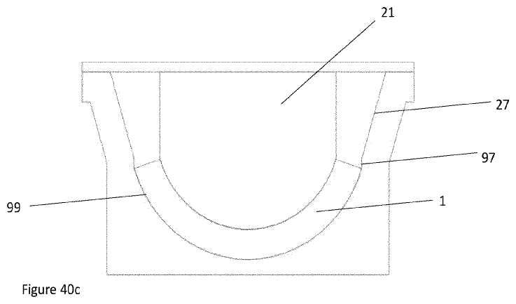

FIG. 40a shows a starting position of an alternative forming method in which the mould 21 is placed above the material 1, with the frame 7 situated under the material, and the bottom of the frame forms a bowl 99 or well.

The frame 7 is formed of a funnel 27 with a central void. The funnel may have any pitch, but the particular embodiment shown has a funnel with an angle of greater than 15 degrees from the horizontal. The central void has a decreasing cross-sectional area towards the base of the funnel. At the base of the funnel there is a step, in this case comprising vertical face 97. There is a join between the funnel and the vertical face. The join is shown as comprising a vertex, however this join may be rounded in other embodiments. It is noted that the vertical face 97 may be offset from vertical, for example such that it is near vertical, so long as the function of the vertical face is unaffected. In particular, the vertical face functions in the same manner as that shown in FIG. 17d regarding the section of the funnel with constant cross-section. In particular, the vertical face may function such that the edge of the shaping region of the material moves outwards and the material begins to bend. In other embodiments this step may comprise a horizontal step, or a step that functions equivalently to a horizontal step. It is noted that in this embodiment length of the step is short. In some embodiments the vertical or horizontal face 97 may have a length of approximately 0.5 mm to 5 mm. Therefore, the amount of bending of the material 1 induced by the vertical or horizontal face 97 may be less than shown in FIG. 17.

Also shown in FIG. 40 the frame comprises a bowl. The bowl may form a complete lower surface of the frame (as shown in the present embodiment), or may comprise one or more apertures at said lower surface. As the material is pushed through the funnel the material then reaches the bowl and conforms to the shape of the bowl.

It is noted that the step comprising the horizontal or vertical face may be optional. The funnel may directly lead into a bowl without the presence of a vertical face. The horizontal or vertical face may reduce the risk of unexpected/unwanted deformation of the material occurring at the funnel to bowl interface.

In FIG. 40a the mould 21 is shown above the material. The frame 7 is shown below the material. Either the frame or the mould may be configured to move. Relative movement between the frame and the mould will lead to shaping, forming and moulding of the material.

FIG. 40b shows the apparatus of FIG. 40a, but at a later stage of the forming process as the mould begins to contact the material and push the material through the frame. This is akin to the stage of forming shown in FIG. 17b. In FIG. 40b the material is in contact with the funnel only. The funnel is beginning to form the material by causing bending/forming in conjunction with the mould 21. The edge of the material is constrained/restricted against the side of the funnel.

FIG. 40c shows the same apparatus as FIGS. 40a and 40b, but at the end of the process with the material 1 moulded by the frame 7, and with the material situated at least partially within the bowl 99 or well of the frame. Between the steps shown in FIGS. 40b and 40c the material 1 may have been formed or bent by the vertical face 97.

FIG. 40c shows the mould 21 inserted fully into the frame 7. In this embodiment the mould 21 has the desired inner curvature of the material 1, and the bowl 99 has the desired outer curvature of the material 1. The material conforms to the shape of the bowl and the mould. The mould therefore has a smaller radius than the bowl. In some embodiments the mould may be configured to stop moving relative to the frame once it is a set distance from the base of the bowl. This set distance may be equal to the thickness of the material (in some embodiments a tolerance may also be added). This may ensure that the material is shaped with minimal deformation of the structure of the top or bottom surface of the material taking place.

The above embodiments are to be understood as illustrative examples. Further embodiments are also envisaged. It is to be understood that any feature described in relation to any one embodiment may be used alone, or in combination with other features described and may also be used in combination with one or more features of any other of the embodiments, or any combination of any other of the embodiments.

Furthermore, equivalents and modifications not described above may also be employed without departing from the scope of the invention, which is defined in the accompanying claims.

It is noted that the above methods may be automated in some embodiments. The method steps may therefore be carried out by robotic means, and the instructions saved to a controller, data storage, or the like.

In some examples, one or more memory elements can store data and/or program instructions used to implement the methods described herein. Embodiments of the disclosure provide tangible, non-transitory storage media comprising program instructions operable to program a processor to said method and/or claimed herein.

The processor/controller of such apparatus (and any of the methods, activities or instructions outlined herein) may be implemented with fixed logic such as assemblies of logic gates or programmable logic such as software and/or computer program instructions executed by a processor. Other kinds of programmable logic include programmable processors, programmable digital logic (e.g. a field programmable gate array (FPGA), an erasable programmable read only memory (EPROM), an electrically erasable programmable read only memory (EEPROM), an application specific integrated circuit (ASIC) or any other kind of digital logic, software, code, electronic instructions, flash memory, optical disks, CD-ROMs, DVD ROMs, magnetic or optical cards, other types of machine-readable mediums suitable for storing electronic instructions, or any suitable combination thereof. Such data storage media may also provide the data storage of the manufacturing device.

What is claimed is:

1. A method of manufacturing an article, the method comprising the steps of:
providing a material;
heating the material;
restricting an edge or region of the material within a frame element;
moving a mould towards the frame or vice versa such that the material is in contact with the mould.

2. The method of claim 1, further comprising shaping the material through the contact with the mould.

3. The method of claim 1, wherein the edge or region is either:
the edge of the portion of the material that is being shaped by the mould, or
the side wall of the material.

4. The method of claim 1, wherein the frame element is a substantially rigid element.

5. The method of claim 1, wherein the frame element contains a cut-out, optionally wherein this is located in the centre of the frame element, optionally wherein the shape of the cut-out corresponds to the cross-sectional shape of the mould.

6. The method of claim 1, wherein the frame element extends perpendicularly to the plane of the cut-out by between 5 mm-20 mm, and preferably 6 mm-12 mm, optionally wherein the extension down is positioned at a midway point in the longitudinal direction of the cut-out of the frame.

7. The method of claim 1, further comprising, prior to restraining an edge of the material, positioning the material either:
on top of the frame element;
underneath the frame element;
on top of the mould;
underneath the mould; optionally
further comprising pushing at least a portion of the material at least partially through the cut-out in the frame, wherein the edge of the portion of the material being shaped is restrained by the frame element as the portion of the material is pushed through the cut-out.

8. The method of claim 1, further comprising removing the material outside the edge of the portion of the material being shaped.

9. The method of claim 1, further comprising forming a score mark on the outer surface of the article, optionally wherein the frame comprises a scoring member, and further comprising the step of the scoring member scoring the outer surface of the article as the material is shaped.

10. The method of claim 1, wherein the frame comprises a second forming element situated at an angle to the first forming element and configured to form the material in a different plane to the first forming element.

11. The method of claim 1, wherein the frame element is a flexible member, such as an inflatable member, optionally wherein the flexible/inflatable member is a torus when inflated with a void in the centre of the flexible or inflatable member.

12. The method of claim 11, further comprising, prior to restraining an edge of the material, positioning the material on top of, or underneath, the flexible/inflatable member; optionally further comprising pushing at least a portion of the material at least partially through the void in the centre of the flexible/inflatable member, wherein the edge of the portion of the material being shaped is restrained by the flexible/inflatable member, optionally further comprising expanding the flexible/inflatable member after the material has been at least partially shaped, and optionally further comprising continuing to shape the material after the flexible/inflatable member has been expanded.

13. The method of claim 1, wherein the frame element is a funnel with a decreasing cross-sectional area, for example the top comprises a central void with a first cross sectional area, and below the top the cross sectional area of the void is decreased, optionally further comprising shaping the material as the mould contacts the material, thereby reducing the cross-section area of the material, optionally further comprising the material descending through the funnel as the cross-sectional area of the material decreases, optionally wherein as the material descends into the funnel it is further shaped by the mould, until the material either exits the funnel or a desired cross sectional area of the material is reached, optionally wherein the frame element comprises a bowl situated beneath the funnel, optionally the method comprising the steps of pushing the material through the funnel and into the bowl, further optionally wherein the method further comprises the material taking the shape of the bowl.

14. The method of claim 1, wherein prior to the method the material comprises a plurality of hollow parallel conjoined tubes, optionally wherein the material comprises a first surface and a second surface connected via the parallel conjoined tubes.

15. An apparatus for thermoforming an article from a material, the apparatus comprising:
a heating source;
a frame;
a mould;
wherein the frame element is configured to restrict an edge or region of the material within a frame element;
wherein the mould is configured to move towards the frame, or vice versa, such that the material is in contact with the mould.

16. The apparatus of claim 15, wherein the frame element is a substantially rigid element, optionally wherein the frame element contains a cut-out, optionally wherein this is located in the centre of the frame element, optionally wherein the shape of the cut-out corresponds to the cross-sectional shape of the mould, optionally wherein the frame element extends down by between 5 mm-20 mm, and preferably 6 mm-12 mm, optionally wherein the extension down is positioned at a midway point in the longitudinal direction of the cut-out of the frame, optionally wherein the frame comprises a second forming element situated at an angle to the first forming element and configured to form the material in a different plane to the first forming element.

17. The apparatus of claim 15, wherein the frame element is an flexible member, such as an inflatable member, optionally wherein the flexible/inflatable member is a torus when inflated with a void in the centre of the flexible or inflatable member, optionally wherein the flexible/inflatable member is bulbous in the middle such that the cross-section of the void is larger at the top/bottom than the middle of the flexible/inflatable member.

18. The apparatus of claim 15, wherein the frame element is a funnel with a decreasing cross-sectional area, for example the top comprises a central void with a first cross sectional area, and below the top the cross sectional area of the void is decreased.

19. The apparatus of claim 15, wherein the material comprises a plurality of hollow parallel conjoined tubes.

20. The apparatus of claim 15, wherein the apparatus is configured to perform the method comprising:
providing the material;
heating the material;
restricting the edge or region of the material within the frame element;
moving the mould towards the frame or vice versa such that the material is in contact with the mould.
